(19) United States
(12) Patent Application Publication
(10) Pub. No.: US 2026/0011721 A1
(43) Pub. Date: Jan. 8, 2026

(54) LITHIUM METAL ANODES, METHODS OF MAKING THE SAME, AND LITHIUM SECONDARY BATTERIES COMPRISING THE SAME

(71) Applicants: Hyundai Motor Company, Seoul (KR); Kia Corporation, Seoul (KR)

(72) Inventors: Areum Ha, Hwaseong (KR); Won Keun Kim, Hwaseong (KR); Jongchan Song, &Hwaseong (KR); Seongmin Ha, Hwaseong (KR); Seungjong Lee, Hwaseong (KR); Jihee Ham, Hwaseong (KR); Kyoung Han Ryu, Hwaseong (KR); Jae Wook Shin, Hwaseong (KR)

(21) Appl. No.: 19/255,297

(22) Filed: Jun. 30, 2025

(30) Foreign Application Priority Data
Jul. 3, 2024 (KR) 10-2024-0087657

(51) Int. Cl. H01M 4/38; H01M 4/02; H01M 4/04; H01M 4/36; H01M 4/62; H01M 10/052

(52) U.S. Cl. CPC H01M 4/382; H01M 4/0435; H01M 4/366; H01M 4/623; H01M 4/625; H01M 4/626; H01M 10/052; H01M 2004/021; H01M 2004/027

(57) ABSTRACT

An energy-dense lithium-metal negative electrode pairs a copper current collector with a lithium-metal layer and a carbon-rich protective coating. The coating suitably contains 70-97 wt % carbon and 3-30 wt % polymer binder, achieves 1.55-2.62 g cm⁻³ density, 11-17% porosity, and 1-10 μm thickness., with a binder-to-carbon ratio of 0.03-0.30. Up to 5 wt % of Ag, Mg, Zn, Si, Ge, Al, or In suitably can be added for better lithium affinity. In preferred aspects, rather than drying the slurry after roll-to-roll lamination, the method involves drying a carbon slurry that has been coated onto a protective substrate, and then roll-to-roll laminating the resulting dried carbon film onto the lithium layer.

### CROSS-REFERENCE TO RELATED APPLICATION

This application claims under 35 U.S.C. § 119(a) the benefit of Korean Patent Application No. 10-2024-0087657 filed in the Korean Intellectual Property Office on Jul. 3, 2024, the entire contents of which are incorporated herein by reference.

### BACKGROUND

### (a) Technical Field

The present disclosure relates to a lithium metal negative electrode, its manufacturing method, and a lithium rechargeable battery comprising the same, specifically to a lithium metal negative electrode comprising a carbon protective layer, its manufacturing method, and a lithium rechargeable battery comprising the same.

### (b) Background

As technology advances and mobile-device usage gros, demand for rechargeable batteries as an energy source is surging. Recently, the use of rechargeable batteries as power sources for electric vehicles (EVs) and energy storage systems (ESS) has become a reality. Consequently, extensive research is being conducted on rechargeable batteries that can meet various demands, and the demand for lithium rechargeable batteries with high power characteristics is increasing.

Currently, commercially available lithium rechargeable batteries primarily use carbon-based compounds like graphite as the negative electrode material. Carbon-based compounds maintain structural and electrical properties without volume change during charging and discharging, allowing for reversible lithium ion insertion and extraction with high stability. Their drawback is a theoretical capacity caps at 372 mAh/g, which limits their suitability for next-generation, high-energy applications.

Accordingly, attention has shifted toward higher-capacity anodes based on lithium alloys, silicon (Si), germanium (Ge), tin (Sn), and aluminum (Al).

Particularly, lithium metal can be used as a negative electrode material. Lithium metal has a theoretical electrical capacity as high as approximately 3,860 mAh/g. However, during charging and discharging, side reactions with the electrolyte can form dendrites on the lithium metal surface, which grow and cause short circuits between the positive and negative electrodes, leading to deterioration in the lifespan characteristics of lithium batteries containing lithium metal.

Therefore, there is a need for development that can improve the lifespan characteristics of batteries while containing lithium metal.

### SUMMARY OF THE DISCLOSURE

The present disclosure provides a lithium metal negative electrode that can improve the lifespan characteristics of lithium metal batteries.

Also, the present disclosure provides a manufacturing method for a lithium metal negative electrode having the aforementioned advantages.

A lithium metal negative electrode according to an embodiment comprises: a current collector; a lithium metal layer positioned on at least one side of the current collector; and a protective layer positioned on the lithium metal layer, wherein the protective layer contains carbon and a binder, and the density of the protective layer is 1.55 to 2.62 g/cm³.

The ratio of the binder to the carbon may satisfy the following Equation 1:

$$0.03 \leq B / ( A + B ) \leq 0.3 \qquad [ Equation 1 ]$$

In Equation 1, A is the content of the carbon, and B is the content of the binder.

The porosity of the protective layer may be 11 to 17%.

The thickness of the protective layer may be 1 to 10 μm.

The content of the carbon may be 70 to 97 wt % based on the entire 100 wt % of the protective layer.

The carbon may include at least one of carbon black, carbon nanotube, carbon nanofiber, artificial graphite, natural graphite, amorphous carbon, crystalline carbon, meso carbon microspheres, hard carbon, and soft carbon.

The content of the binder may be 3 to 30 wt % based on the entire 100 wt % of the protective layer.

The binder may include at least one of polyvinylidene fluoride (PVdF), carboxyl methyl cellulose (CMC), styrene-butadiene rubber (SBR), polyacrylic acid (PAA), and poly(vinylidene fluoride-co-hexafluoropropylene) (PVdF-HFP).

The protective layer may further include a lithium affinity material.

The lithium affinity material may include at least one of Ag, Mg, Zn, Sn, Si, Ge, Al, and In.

The protective layer may further include about 0.1 to 5 wt % of a lithium-affinity metal selected from Ag, Mg, Zn, Si, Ge, Al and In, the lithium-affinity

A method of manufacturing a lithium metal negative electrode according to another embodiment of the present disclosure comprises: preparing a current collector; forming a lithium metal layer on at least one surface of the current collector; and forming a protective layer on the surface of the lithium metal layer, wherein the step of forming the protective layer includes mixing carbon and a binder, forming a film on the surface of a protective substrate, and then drying it.

The tensile strength of the protective substrate may be 300 to 1425 MPa.

The protective substrate may include at least one of Ni, Cu, Fe—Ni alloy, and SUS.

The step of forming a lithium metal layer on at least one surface of the current collector may involve coating or depositing it on the current collector.

The step of forming the protective layer may involve transferring the protective layer onto the surface of the lithium metal layer through a roll-to-roll rolling process.

The drying temperature of the drying step may be 130 to 170° C.

The drying time of the drying step may be 6 to 24 hours.

The lithium-metal layer may be electrodeposited at a current density of about 1 to 12 mA cm⁻² and subsequently pressed to about 300 to 1,425 MPa to the lithium-metal layer before the protective layer is applied.

A lithium rechargeable battery according to another embodiment of the present disclosure comprises a positive electrode, a negative electrode, and an electrolyte interposed between the positive and negative electrodes, wherein the negative electrode is the aforementioned lithium metal negative electrode.

A lithium metal negative electrode according to an embodiment can reduce the problem of dendrite formation on the surface of lithium metal, which deteriorates the lifespan of lithium metal batteries, by forming a protective layer on top of the lithium metal.

A method of manufacturing a lithium metal negative electrode according to another embodiment of the present disclosure can increase the composition and density of a protective layer that allows for the underlying deposition of lithium.

### BRIEF DESCRIPTION OF THE DRAWINGS

FIG. 1 is a drawing illustrating a lithium metal battery including a protective layer on a lithium metal negative electrode according to some embodiments of the present disclosure.

FIG. 2 is a scanning electron microscope (SEM) image related to the surface density according to the density difference of the protective layer formed on the lithium metal negative electrode according to some embodiments of the present disclosure.

FIG. 3 is a scanning electron microscope (SEM) image related to the surface density according to the density difference of the protective layer formed on the lithium metal negative electrode according to a Comparative Example of the present disclosure.

FIG. 4 is an optical photograph of a coin-type lithium-metal negative electrode covered with a carbon-containing protective layer whose density is at least 1.55 g cm⁻³, showing a smooth, uniform surface without visible lithium deposits, according to some embodiments of the present disclosure.

FIG. 5 is an optical photograph of th lithium-metal negative electrode of FIG. 4 after electrochemical cycling, illustrating that only a few isolated lithium nucleation sites appear while bulk deposition remains suppressed under th high-density protective layer, according to some embodiments of the present disclosure.

FIG. 6 is an optical photograph of th lithium-metal negative electrode of FIG. 4 after extended cycling, exhibiting a concentric deposition pattern that confirms uniform lithium plating/stripping beneath the intact high-density protective layer, according to some embodiments of the present disclosure.

FIG. 7 is an optical photograph of a lithium-metal negative electrode having a protective layer whose density is less than 1.55 g cm⁻³, illustrating widespread surface lithium deposition and a crack in the layer, thereby demonstrating loss of protective layer function, according to a Comparative Example of the present disclosure.

FIG. 8 is a schematic view of the process of manufacturing a protective layer through a transfer process on a lithium metal negative electrode according to some embodiments of the present disclosure.

FIG. 9 is a scanning electron microscope (SEM) image of the lithium metal negative electrode with a protective layer formed thereon according to some embodiments of the present disclosure.

FIG. 10 is a scanning electron microscope (SEM) image after additional lithium deposition on the lithium metal negative electrode with a protective layer formed thereon according to some embodiments of the present disclosure.

FIG. 11 shows the evaluation results of the protective layer density according to the type of coating substrate in some embodiments of the present disclosure.

FIG. 12 shows the evaluation results of the discharge capacity of a lithium metal battery according to some embodiments and a Comparative Example of the present disclosure.

FIG. 13 shows the evaluation results of the overvoltage tendency during initial lithium deposition of a lithium metal battery according to some embodiments and a Comparative Example of the present disclosure.

### DETAILED DESCRIPTION OF THE EMBODIMENTS

In this specification, the terms such as first, second, and third are used to describe various parts, components, regions, layers, and/or sections, but are not limited thereto. These terms are used only to distinguish one part, component, region, layer, or section from another. Therefore, a first part, component, region, layer, or section described below may be referred to as a second part, component, region, layer, or section within the scope of the present disclosure.

The technical terms used herein are merely for referencing specific embodiments and are not intended to limit the present disclosure. The singular forms used herein include plural forms as long as the phrases do not explicitly indicate otherwise. The term “comprising/including/containing/having” as used in the specification specifies certain characteristics, regions, integers, steps, operations, elements, and/or components but does not exclude the presence or addition of other characteristics, regions, integers, steps, operations, elements, and/or components.

When a part is said to be “on” or “above” another part, it can be directly on or above the other part, or there may be intervening parts. Conversely, when a part is stated to be “directly on” another part, there are no intervening parts.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “porosity” herein refers to the volume fraction of voids in the protective layer as measured by mercury-intrusion porosimetry in accordance with ASTM D4284.

The term “density” herein refers to the mass per unit volume of the protective layer, determined by X-ray reflectometry at 25° C.

The term “tensile strength” herein refers to the ultimate ensile stress of the lithium-metal layer measured by a uniaxial pull test (ISO 6892-1).Ple

Unless otherwise defined, all terms including technical and scientific terms used herein have the same meaning as commonly understood by one of ordinary skill in the art to which this disclosure belongs. Terms defined in commonly used dictionaries should be interpreted as having meanings that are consistent with their meaning in the context of the relevant art and the present disclosure and should not be interpreted in an idealized or overly formal sense unless expressly so defined.

Moreover, unless specifically mentioned otherwise, % refers to wt %, and 1 ppm is 0.0001 wt %.

In this specification, the term “combinations thereof” in the Markush expression means one or more mixtures or combinations selected from the group consisting of the components described in the Markush expression, meaning that it includes one or more selected from the group consisting of the components.

Hereinafter, some embodiments of the present disclosure will be described in detail to be easily implemented by one of ordinary skill in the art to which the present disclosure belongs. However, the present disclosure can be implemented in various different forms and is not limited to the embodiments described herein. As those skilled in the art would realize, the described embodiments may be modified in various different ways, all without departing from the spirit or scope of the present disclosure.

### 1. Lithium Metal Negative Electrode

A lithium metal negative electrode according to some embodiments comprises a current collector; a lithium metal layer positioned on at least one surface of the current collector; and a protective layer positioned on the surface of the lithium metal layer. The protective layer includes carbon and a binder coated on a protective substrate, and the density of the protective layer is 1.55 to 2.62 g/cm³. Specifically, the density of the protective layer can be 1.55 to 2.05 g/cm³, and more specifically, 1.55 to 1.70 g/cm³. When the density of the protective layer satisfies this range, a dense protective layer is formed on the surface of the lithium negative electrode, which easily leads to lithium ion saturation within the carbon protective layer and allows lithium deposition beneath the protective layer, thereby suppressing interface reactions with the electrolyte. Conversely, if the density of the protective layer is less than 1.55 g/cm³, lithium may deposit on the upper part of the protective layer, potentially leading to a loss of protective layer function.

In a lithium metal negative electrode according to some embodiments, the ratio of the binder to the carbon may satisfy the following Equation 1.

$$0.03 \leq B / ( A + B ) \leq 0.3 \qquad [ Equation 1 ]$$

In Equation 1, A is the content of the carbon and B is the content of the binder. When the ratio of the binder to the carbon satisfies Equation 1, a dense protective layer is formed on the surface of the lithium negative electrode, which easily leads to lithium ion saturation within the protective layer and allows lithium deposition beneath the protective layer, thereby suppressing interface reactions with the electrolyte. Conversely, if the ratio of the binder to the carbon deviates from Equation 1, a dense protective layer may not form, leading to continuous decomposition reactions between the electrolyte and lithium, which can result in electrolyte depletion and increased interface resistance, causing cell performance degradation.

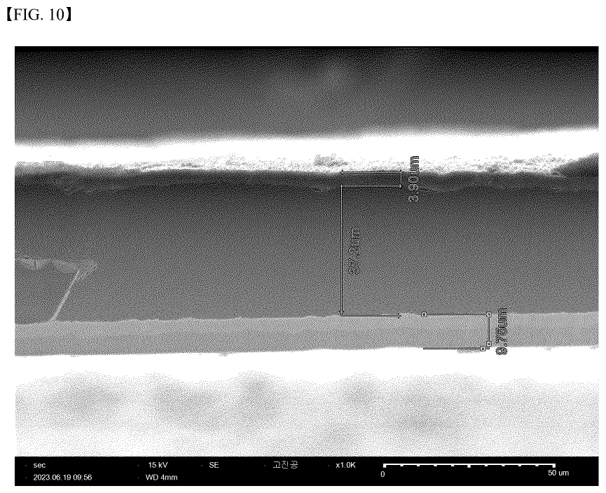

FIG. 9 is a scanning electron microscope (SEM) image of a lithium metal negative electrode with a protective layer formed according to some embodiments.

FIG. 10 is an SEM image of a lithium metal negative electrode with a protective layer formed according to some embodiments after additional lithium deposition.

Referring to FIGS. 9 and 10, it can be confirmed that a lithium metal negative electrode with a 20 μm thickness of a coated protective layer can accommodate additional lithium deposition of 4 mAh/cm², resulting in an increased thickness of 37.2 μm after additional lithium deposition.

In a lithium metal negative electrode according to some embodiments, the porosity of the protective layer may be 11 to 17%, specifically 12 to 17%, and more specifically 13 to 17%. When the porosity of the protective layer satisfies this range, it allows for lithium deposition beneath the lithium metal, improving the structural stability of the negative electrode material, efficiently suppressing volume expansion of the negative electrode material, reducing the expansion rate, and enhancing the cycling performance of the battery. Conversely, if the porosity of the protective layer deviates from this range, contact between the lithium metal and the electrolyte may occur, leading to the formation of dendrites on the lithium metal surface.

In a lithium metal negative electrode according to some embodiments, the thickness of the protective layer may be 1 to 10 μm, specifically 2 to 8 μm, and more specifically 3 to 6 μm. When the thickness of the protective layer satisfies this range, it easily leads to lithium ion saturation within the carbon protective layer, allowing lithium to deposit beneath the protective layer, thereby easily suppressing interface reactions with the electrolyte. Conversely, if the thickness of the protective layer is less than 1 μm, issues of interface instability due to interface reactions between the lithium metal and the electrolyte may arise. Additionally, if the thickness of the protective layer exceeds 10 μm, it may become difficult for lithium ions to reach the lithium through the carbon layer, and reduction of lithium ions may occur between the lithium and the carbon layer, leading to a situation where lithium ions cannot move beneath the carbon layer. Furthermore, the movement of electrons through the carbon layer may become easier than the movement of lithium ions, increasing the likelihood of lithium growing on the top of the protective layer.

In a lithium metal negative electrode according to some embodiments, the content of the carbon may be 70 to 97 wt % based on the entire 100 wt % of the protective layer, specifically 75 to 97 wt %, and more specifically 80 to 97 wt %. When the content of the carbon satisfies this range, a protective layer comprising a dense carbon layer can be formed. Conversely, if the content of the carbon is less than 70 wt %, the density of the protective layer containing carbon may not be high, leading to a problem of decreased density. Additionally, if the content of the carbon exceeds 90 wt %, the binding effect between particles in the carbon protective layer may deteriorate, reducing the film-forming property of the coating and causing issues of durability deterioration.

In a lithium metal negative electrode according to some embodiments, the carbon may include at least one of carbon black, carbon nanotube, carbon nanofiber, artificial graphite, natural graphite, amorphous carbon, crystalline carbon, meso-carbon microbeads, hard carbon, and soft carbon, but is not limited thereto, and any carbon that can be used as a protective layer is possible.

In a lithium metal negative electrode according to some embodiments, the content of the binder may be 3 to 30 wt % based on the entire 100 wt % of the protective layer, specifically 15 to 30 wt %, and more specifically 20 to 30 wt %. When the content of the binder satisfies this range, proper adhesion between the carbon and the protective substrate can be achieved. Conversely, if the content of the binder is less than 3 wt %, the adhesive strength between the carbon and the protective substrate may weaken, leading to delamination and issues of decreased mechanical strength. Additionally, if the content of the binder exceeds 30 wt %, it may increase electrical resistance and lower the content of carbon, failing to adequately function as a protective layer between the lithium metal and the electrolyte, causing issues of battery output power deterioration.

In a lithium metal negative electrode according to some embodiments, the binder may include at least one of polyvinylidene fluoride (PVdF), carboxyl methyl cellulose (CMC), and styrene-butadiene rubber (SBR), but is not limited thereto, and any binder that can coat carbon on the protective substrate is possible.

In a lithium metal negative electrode according to some embodiments, the protective layer may further include a lithium affinity material. The lithium affinity material may serve to assist in the deposition of lithium within the protective layer.

In a lithium metal negative electrode according to some embodiments, the lithium affinity material may include at least one of Ag, Mg, Zn, Sn, Si, Ge, Al, and In, but is not limited thereto, and any material that forms an alloy with lithium and has good affinity with lithium is possible.

### 2. Method for Manufacturing a Lithium Metal Negative Electrode

A method for manufacturing a lithium metal negative electrode according to another embodiment of the present disclosure comprises: preparing a current collector; forming a lithium metal layer on at least one surface of the current collector; and forming a protective layer on the surface of the lithium metal layer, wherein the step of forming the protective layer includes mixing carbon and a binder on the surface of a substrate to form a film on the substrate and then drying it.

In the method for manufacturing a lithium metal negative electrode according to another embodiment of the present disclosure, the tensile strength of the substrate may be 300 to 1,425 MPa, preferably 500 to 1,200 MPa, and more preferably 700 to 1,000 MPa. When the tensile strength of the substrate satisfies this range, a dense protective layer with a density of 1.55 g/cm³ or more can be formed. Conversely, if the tensile strength of the substrate is outside this range, there may be a problem in forming a protective layer with a low porosity over lithium with low hardness.

In the method for manufacturing a lithium metal negative electrode according to another embodiment of the present disclosure, the substrate may include at least one of Ni, Cu, Fe—Ni alloy, and SUS, but is not limited thereto, and any metallic substrate with a tensile strength of 300 MPa or more can be used. Referring to FIG. 11, it was confirmed that when using a film with low tensile strength and hardness, such as PTFE (Polytetrafluoroethylene), as a substrate for the protective layer, the density of carbon was not high. In contrast, when using a substrate with high tensile strength and hardness, such as Cu or Ni alloy, a dense carbon layer with a density of 1.55 g/cm³ or more was formed.

In the method for manufacturing a lithium metal negative electrode according to another embodiment of the present disclosure, the step of forming a lithium metal layer on at least one surface of the current collector can be performed by coating or depositing on the current collector, but is not limited to these methods, and any process capable of forming a lithium metal layer on at least one surface of the current collector can be employed.

In the method for manufacturing a lithium metal negative electrode according to another embodiment of the present disclosure, the step of forming the protective layer involves transferring the protective layer onto the surface of the lithium metal layer through a roll-to-roll rolling process.

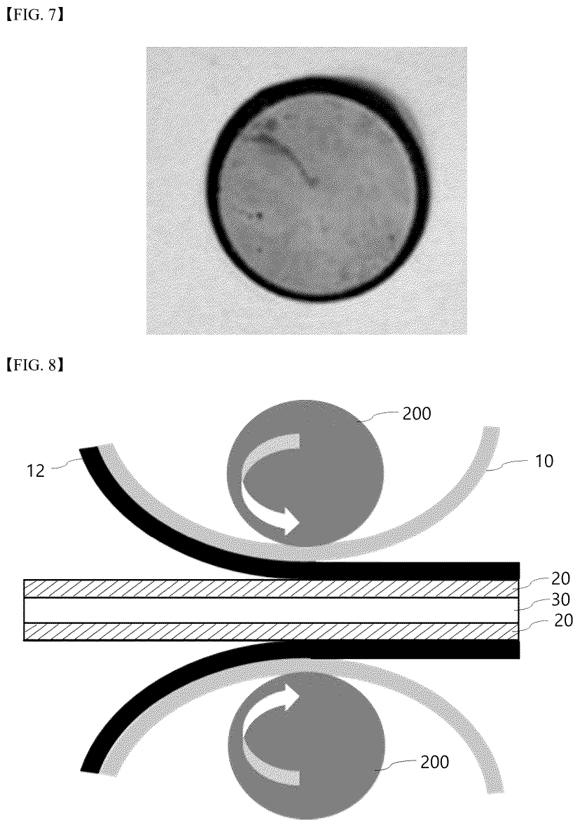

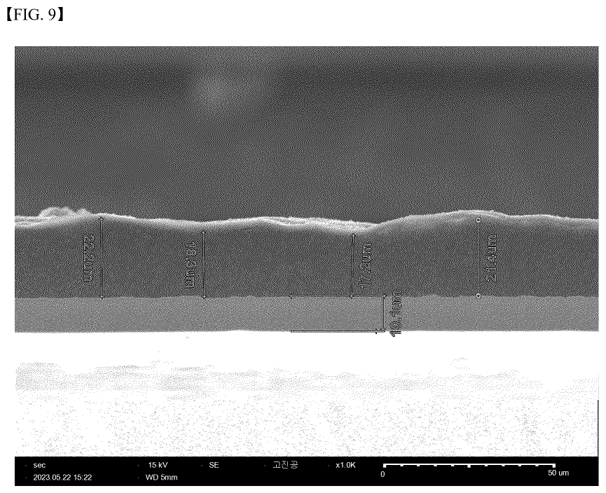

FIG. 8 is a schematic view illustrating the process of manufacturing a protective layer by a transfer process on a lithium metal negative electrode according to some embodiments. Referring to FIG. 8, by using a protective layer coating substrate 10, specifically a metallic substrate transfer paper, the protective layer 12 is transferred onto the lithium electrode, and then the protective layer coating substrate 10 is separated, confirming that the protective layer 12 is formed on both sides of the lithium through a roll-to-roll rolling process.

In the method for manufacturing a lithium metal negative electrode according to another embodiment of the present disclosure, the drying temperature in the drying step may be 130 to 170° C., specifically 140 to 160° C., and more specifically 150 to 155° C. When the drying temperature satisfies this range, carbon and binder can be appropriately coated on the substrate. Conversely, if the drying temperature is below 130° C., there may be a problem where the solvent of the binder is not properly removed, resulting in carbon not adhering to the substrate.

In the method for manufacturing a lithium metal negative electrode according to another embodiment of the present disclosure, the drying time in the drying step may be 6 to 24 hours, specifically 8 to 20 hours, and more specifically 10 to 18 hours. When the drying time satisfies this range, carbon and binder can be appropriately coated on the substrate. Conversely, if the drying time is less than 6 hours, there may be a problem where the solvent of the binder is not properly removed.

### 3. Lithium Rechargeable Battery

In a lithium rechargeable battery comprising a positive electrode, a negative electrode, and an electrolyte interposed between the positive electrode and the negative electrode, the battery includes the aforementioned lithium metal negative electrode.

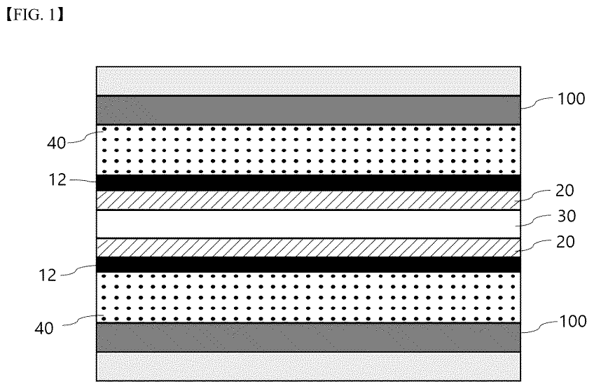

FIG. 1 is a drawing illustrating a lithium metal battery including a protective layer on a lithium metal negative electrode according to some embodiments, which allows one to verify the structure of a lithium rechargeable battery comprising the aforementioned lithium metal negative electrode.

The lithium rechargeable battery further comprises a separator positioned between the positive electrode for lithium rechargeable batteries and the aforementioned lithium metal negative electrode, and the electrolyte may be impregnated in the separator. This structure follows generally known methods in the industry, using the aforementioned positive electrode for lithium rechargeable batteries and lithium metal, placing a separator between them to form an electrode assembly, embedding the electrode assembly in a battery case, and injecting the electrolyte into the separator.

By the electrolyte injected into the separator, the aforementioned lithium metal negative electrode can proceed with activation by charging after discharging in a sufficiently wetted state.

Meanwhile, in the lithium rechargeable battery of some embodiments, components other than the positive electrode coating layer and the positive electrode containing it may adopt those generally known in the industry.

The lithium metal negative electrode can be manufactured by depositing lithium metal on one or both sides of a planar negative electrode current collector or by rolling lithium foil. In this case, the negative electrode current collector may specifically be a copper foil.

The copper foil can generally be made with a thickness of 3 to 100 micrometers, and the metal lithium formed on such copper foil can be formed with a thickness of, for example, 1 to 300 micrometers. Alternatively, a negative electrode composed solely of lithium metal may also be used.

The separator is interposed between the positive electrode and the negative electrode, and a thin insulating film with high ion permeability and mechanical strength is used. The pore diameter of the separator is generally 0.01 to 10 micrometers, and the thickness is generally 5 to 300 micrometers. Such a separator can be, for example, an olefin-based polymer like polypropylene with chemical resistance and hydrophobicity; a sheet or non-woven fabric made of glass fiber or polyethylene. When a solid electrolyte such as a polymer is used as the electrolyte, the solid electrolyte may also serve as the separator.

The electrode assembly, without being limited in structure, may be a stacked electrode assembly where positive electrode, separator, and negative electrode are punched as unit electrodes and stacked, a jelly roll-type electrode assembly where positive electrode sheet, separator, and negative electrode sheet are stacked and wound, or a stack and folding-type electrode assembly where unit electrodes are arranged on a sheet separation film and wound.

The battery case may be a pouch-type battery case made of an aluminum laminate sheet; or a prismatic or cylindrical battery case made of a metal can.

The electrolyte can include organic liquid electrolytes, inorganic liquid electrolytes, solid polymer electrolytes, gel polymer electrolytes, solid inorganic electrolytes, molten-type inorganic electrolytes, etc., which can be used in manufacturing lithium rechargeable batteries, but is not limited to these.

Specifically, the organic liquid electrolyte, i.e., the electrolyte, may include an organic solvent and a lithium salt.

The organic solvent can be used without particular limitation as long as it can serve as a medium in which ions involved in the electrochemical reaction of the battery can move. Specifically, the organic solvent may include ester-based solvents like methyl acetate, ethyl acetate, γ-butyrolactone, ε-caprolactone; ether-based solvents like dibutyl ether or tetrahydrofuran; ketone-based solvents like cyclohexanone; aromatic hydrocarbon-based solvents like benzene, fluorobenzene; carbonate-based solvents like dimethyl carbonate (DMC), diethyl carbonate (DEC), methylethyl carbonate (MEC), ethylmethyl carbonate (EMC), ethylene carbonate (EC), propylene carbonate (PC); ether-based solvents like dimethoxyethane (DME), diethyl ether, ethylene glycol dimethyl ether (EGDME), tetraethylene glycol dimethyl ether (TEGDME); dioxolane like 1,3-dioxolane (DOL); furan like tetrahydrofuran (THF), 2-methyltetrahydrofuran (2MeTHF); alcohol-based solvents like ethanol, isopropyl alcohol; nitrile like R—CN (where R is a linear, branched, or cyclic hydrocarbon group of C2 to C20, possibly including double bond aromatic rings or ether bonds); amide like dimethyl formamide; or sulfolane. Among these, carbonate-based solvents or ether-based solvents are preferred, and a mixture of cyclic carbonate with high ion conductivity and high dielectric constant (e.g., ethylene carbonate or propylene carbonate) and a low-viscosity linear carbonate compound (e.g., ethylmethyl carbonate, dimethyl carbonate, or diethyl carbonate) is more preferred. In this case, mixing cyclic carbonate and linear carbonate in a volume ratio of about 1:1 to about 1:9 can result in excellent electrolyte performance.

A mixture of linear ether with excellent reduction stability that can enhance the reversible charging and discharging performance of lithium metal (e.g., dimethoxy ether, ethylene glycol dimethyl ether) and cyclic dioxolane may also be used.

The lithium salt can be used without particular limitation as long as it can provide lithium ions used in lithium rechargeable batteries. Specifically, the lithium salt may include LiPF₆, LiClO₄, LiAsF₆, LiBF₄, LiSbF₆, LiAl)₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiCl, LiI, or LiB(C₂O₄)₂. The concentration of the lithium salt can be used in the range of 0.1 M to 2.0 M or in the range of 2.0 M to 6.0 M. When the concentration of the lithium salt is included in the range of 0.1 M to 2.0 M, the electrolyte can exhibit excellent electrolyte performance with appropriate conductivity and viscosity, and lithium ions can move effectively. When the concentration of the lithium salt is included in the range of 2.0 M to 6.0 M, the transference degree of lithium increases, allowing lithium ions to move effectively, and the coordination of the electrolyte solvent with the lithium salt improves the oxidation and reduction stability of the electrolyte solvent, suppressing the corrosion of lithium metal and the current collector.

In addition to the components of the electrolyte, additives such as haloalkylene carbonate compounds like difluoro ethylene carbonate, pyridine, triethyl phosphite, triethanolamine, cyclic ether, ethylene diamine, n-glyme (glyme), hexaphosphoric acid triamide, nitrobenzene derivatives, sulfur, quinone imine dye, N-substituted oxazolylidone, N,N-substituted imidazolidine, ethylene glycol dialkyl ether, ammonium salts, pyrrole, 2-methoxy ethanol, or aluminum trichloride may also be included in one or more to improve the lifespan characteristic of the battery, suppress the reduction of battery capacity, improve the discharge capacity of the battery, etc.

However, the above contents are merely examples of components and methods generally known in the industry and can be modified according to the technical knowledge of a person of ordinary skill in the art.

The lithium metal rechargeable battery of some embodiments can also be provided as a battery module including it as a unit cell and a battery pack including it.

The battery module or battery pack can be used as a power source for medium to large devices, including a power tool; electric vehicles (EV), hybrid electric vehicles, and plug-in hybrid electric vehicles (PHEV); or an electric power storage system.

### Embodiment 1

### (Lithium Deposition Process)

In order to form a lithium metal layer on at least one surface of the current collector, the lithium supply source and the current collector in the plating solution were electrically insulated and laminated, and then a power supply was used to press a lithium metal plate with a purity of 99.9% or higher and a thickness of 500 μm onto a copper current collecting plate (Cu plate), and the lithium supply source and the current collector were connected to (+) and (−), respectively, to apply current.

At this time, in order to confirm the electrodeposition behavior at high current density, lithium electrodeposition was performed with a total charge of 4 mAh/cm² at the following current amounts and times in the order of 0.2 mA/cm²×10 min, 0.5 mA/cm²×10 min, 1.0 mA/cm²×10 min, and 12 mA/cm²×18 min 30 s @45° C., to manufacture a lithium metal thin film layer.

At this time, the reduction decomposition reaction of the plating solution on the surface of the current collector and the reaction between the deposited lithium metal thin film layer and the plating solution were controlled to form a film on the surface of the lithium metal thin film layer.

At this time, 1,2-dimethoxyethane solvent was used as the plating solution. Lithium bis(fluorosulfonyl)imide, as nitrogen-based compound, and lithium nitrate were added at 40 wt % and 10 wt %, respectively, with 100 wt % of the plating solution as a reference. Fluoroethylene carbonate, as a fluorine-based compound, was added at 10 wt % with 100 wt % of the plating solution as a reference.

### (Preparation of Lithium Metal Negative Electrode)

A slurry mixed with 90 wt % carbon C65 and 10 wt % binder (PVdF) was deposited on a heavy metal film and vacuum-dried at 130° C. for more than 6 hours to produce a protective layer. The manufactured protective layer was transferred to at least one side of the lithium metal using a rolling mill to form a protective layer.

### Embodiment 2

It was manufactured in the same manner as embodiment 1, except that a slurry containing 80 wt % carbon C65 and 20 wt % binder (PVdF) was used.

### Embodiment 3

It was manufactured in the same manner as embodiment 1, except that a slurry containing 70 wt % carbon C65 and 30 wt % binder (PVdF) was used.

### Comparative Example 1

It was manufactured in the same manner as embodiment 1, except that a slurry containing 90 wt % carbon C65 and 10 wt % binder (PVdF) was used and that the transfer process was performed on a low-strength substrate.

### Comparative Example 2

A lithium metal negative electrode without a carbon protective layer was manufactured.

Experimental Example 1: density

When measuring the density of a protective layer manufactured according to the above-described embodiment and comparative example, the weight and volume of the protective layer were measured, and the results calculated using equation 1 below are shown in Table 1 below.

$$density = weight / volume \qquad [ Equation 1 ]$$

### Experimental Example 2: Porosity

The results calculated using equation 2 below from the measured density during the porosity measurement of the protective layer manufactured according to the embodiment and comparative example described above are shown in Table 1 below.

$$Porosity ( \% ) = ( true density - measured density ) / true density \times 100 \qquad [ Equation 2 ]$$

### Experimental Example 3: Cell evaluation

A lithium metal negative electrode having a protective layer formed according to the above-described embodiment and Comparative Example was manufactured and utilized by inserting a Li(Ni_{0.8}Co_{0.1}Mn_{0.1})O₂ positive electrode and a separator into a cell. At this time, the capacity per area of the positive electrode was 4.0 mAh/cm², and the cell was manufactured by injecting 5 g/Ah of electrolyte. The charging and discharging characteristics of the manufactured lithium metal battery were evaluated by setting the charging current to 0.33 C and the discharge current to 0.33 C.

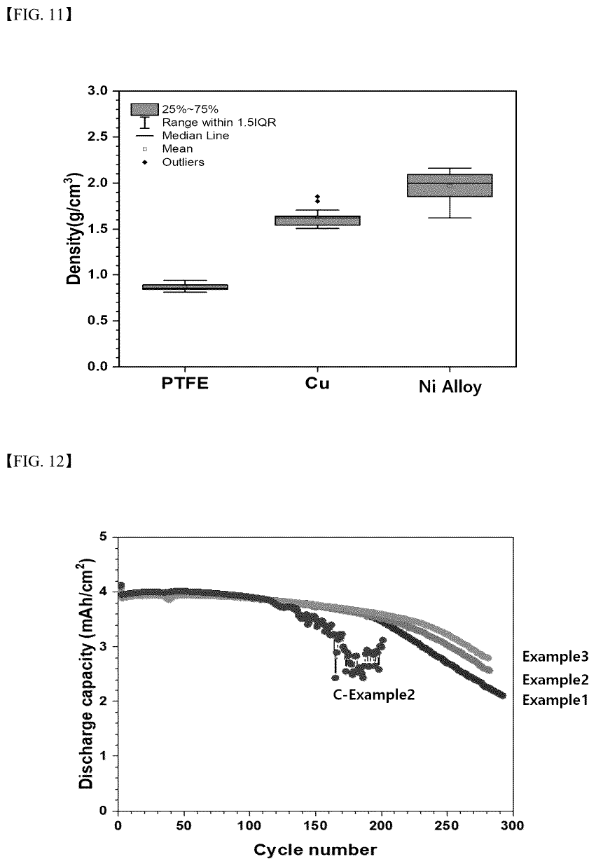

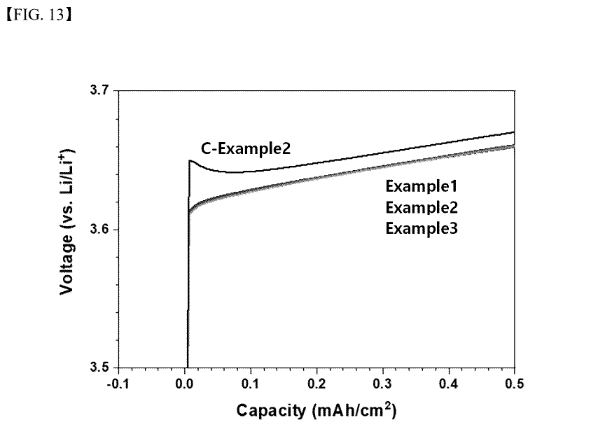

FIG. 12 is a graph of the discharge capacity of some embodiments and a comparative example. Referring to FIG. 12, it was confirmed that embodiments 1 to 3 using a lithium metal negative electrode with a protective layer showed improved cell durability performance compared to Comparative Example 2 without a protective layer.

FIG. 13 is a graph showing the results of evaluating the overvoltage tendency during the initial lithium deposition of a lithium metal battery according to some embodiments and a comparative example. Referring to FIG. 13, when operating a cell using a lithium metal negative electrode with a protective layer applied, it was confirmed that the overvoltage at the initial lithium deposition of embodiments 1 to 3 was reduced compared to Comparative Example 2.

TABLE 1

| | protective layer | | | |
|---|---|---|---|---|
| | composition | | | |
| | carbon | binder | protective layer | |
| | (wt %) | (wt %) | density(g/cm³) | porosity (%) |
| embodiment 1 | 90 | 10 | 1.62 | 16 |
| embodiment 2 | 80 | 20 | 1.64 | 14 |
| embodiment 3 | 70 | 30 | 1.61 | 15 |
| Comparative | 90 | 10 | <1.55 | >16 |
| Example 1 | | | | |
| Comparative | — | — | — | — |
| Example 2 | | | | |

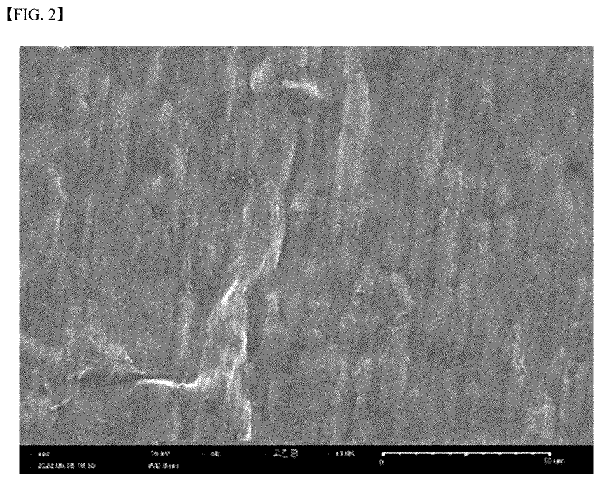

Referring to Table 1, it can be confirmed that embodiments 1 to 3 formed a dense protective layer with a density of 1.55 g/cm³ or more and a porosity of 16% or less, compared to Comparative Example 2 where a protective layer was not formed. FIGS. 2 and 3 are scanning electron microscope (SEM) images comparing surface density according to difference in protective layer density. FIG. 2 is a scanning electron microscope (SEM) image that can confirm the density of the protective layer surface of embodiment 1, compared to Comparative Example 1 of FIG. 3, which has the same composition but was transferred to a low-strength substrate during the transfer process, the density of the protective layer was confirmed to be higher.

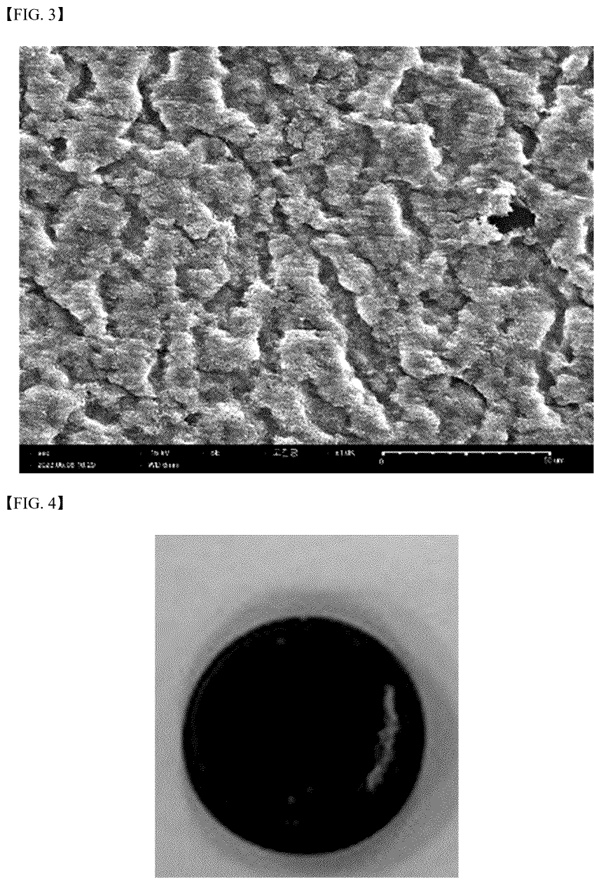

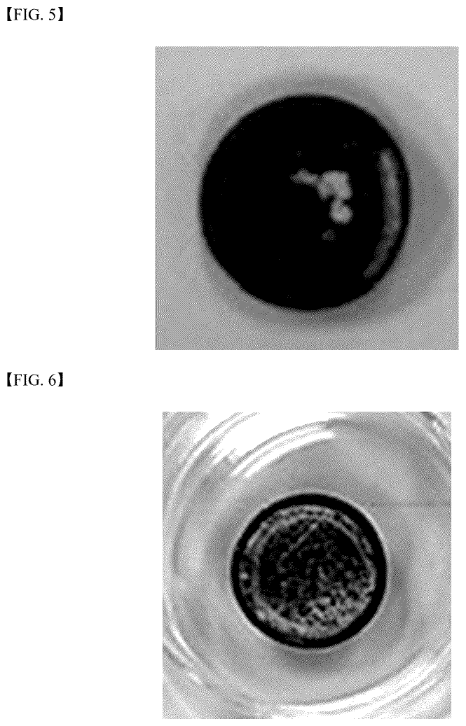

FIGS. 4 to 7 are images confirming the lithium surface deposition shape according to the carbon content of the protective layer and the density of the protective layer. Referring to FIGS. 4 to 6, it was confirmed that the function was maintained by the electrodeposition under the lithium protective layer because the density of the protective layer was 1.55 g/cm³ or higher. On the other hand, referring to FIG. 7, when the density of the protective layer is less than 1.55 g/cm³, it was confirmed that lithium was deposited on the upper part of the protective layer, resulting in the loss of the protective layer function.

Although the present disclosure has been described above with regard to a preferably embodiment thereof, the present disclosure is not limited thereto, and it is possible to implement the present disclosure by modifying it in various ways within the scope of the patent claims and the detailed description and accompanying drawings of the disclosure, and this also naturally falls within the scope of the present disclosure.

Therefore, it can be said that the actual scope of the present disclosure is defined by the attached patent claims and their equivalents.

### DESCRIPTION OF SYMBOLS

10 protective layer coating substrate
12 protective layer
20 lithium metal
30 current collector
40 electrolyte
100 positive electrode
200 rolling mill

What is claimed is:

1. A lithium metal negative electrode comprising:
a current collector;
a lithium metal layer positioned on at least one side of the current collector; and
a protective layer positioned on the lithium metal layer;
wherein the protective layer contains a carbon and a binder, and
wherein a density of the protective layer is about 1.55 to 2.62 g/cm³.

2. The lithium metal negative electrode of claim 1, wherein:
a ratio of the binder to the carbon satisfies 0.03≤B/(A+B)≤0.3,
wherein A is a content of the carbon, and B is a content of the binder.

3. The lithium metal negative electrode of claim 1, wherein:
a porosity of the protective layer is about 11 to 17%.

4. The lithium metal negative electrode of claim 1, wherein:
a thickness of the protective layer is about 1 to 10 μm.

5. The lithium metal negative electrode of claim 2, wherein:
the carbon content is about 70 to 97 wt % based on 100 wt % of the protective layer.

6. The lithium metal negative electrode of claim 2, wherein:
the carbon includes at least one of carbon black, carbon nanotube, carbon nanofiber, artificial graphite, natural graphite, amorphous carbon, crystalline carbon, meso carbon microspheres, hard carbon and soft carbon.

7. The lithium metal negative electrode of claim 2, wherein:
the binder content is about 3 to 30 wt % based on 100 wt % of the protective layer.

8. The lithium metal negative electrode of claim 2, wherein:
the binder contains at least one of polyvinylidene fluoride (PVdF), carboxyl methyl cellulose (CMC), styrene-butadiene rubber (SBR), polyacrylic acid (PAA), and poly(vinylidene fluoride-co-hexafluoropropylene) (PVdF-HFP).

9. The lithium metal negative electrode of claim 1, wherein:
the protective layer further contains a lithium affinity material.

10. The lithium metal negative electrode of claim 9, wherein:
the lithium affinity material includes at least one of Ag, Mg, Zn, Sn, Si, Ge, Al, and In.

11. The lithium metal negative electrode of claim 10, wherein the protective layer further comprises about 0.1 to 5 wt % of a lithium-affinity metal selected from Ag, Mg, Zn, Si, Ge, Al and In, the lithium-affinity

12. A method of preparing a lithium metal negative electrode, the method comprising:
preparing a current collector;
forming a lithium metal layer on at least one surface of the current collector; and
forming a protective layer on the lithium metal layer surface;
wherein forming the protective layer includes mixing a carbon and a binder, forming a film on a surface of a protective substrate using the mixture, and then drying the film.

13. The method of claim 12, wherein:
a tensile strength of the protective substrate is about 300 to 1425 MPa.

14. The method of claim 12, wherein:
the protective substrate contains at least one of Ni, Cu, Fe—Ni alloy and SUS.

15. The method of claim 12, wherein:
forming the lithium metal layer on at least one surface of the current collector is carried out by coating or depositing lithium metals on the current collector.

16. The method of claim 12, wherein:
forming the protective layer comprises transferring the protective layer onto the lithium metal layer surface through a roll-to-roll rolling process.

17. The method of claim 12, wherein:
a drying temperature of the drying is about 130 to 170° C.

18. The method of claim 12, wherein:
a drying time of the drying is about 6 to 24 hours.

19. A lithium rechargeable battery, comprising:
a positive electrode, a negative electrode, and an electrolyte interposed between the positive electrode and negative electrode,
wherein the negative electrode is the lithium metal negative electrode of claim 1.

20. The method of claim 12, wherein the lithium-metal layer is electrodeposited at a current density of about 1 to 12 mA cm⁻² and subsequently pressed to about 300 to 1,425 MPa to the lithium-metal layer before the protective layer is applied.
